(19) United States
(12) Patent Application Publication
(10) Pub. No.: US 2010/0302919 A1
(43) Pub. Date: Dec. 2, 2010

(54) Optical Recording Method and Apparatus

(75) Inventors: Yu-Wei Ling, Hsinchu City (TW); Yih-Shin Weng, Jhubei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/822,263

(22) Filed: Jun. 24, 2010

Related U.S. Application Data
(63) Continuation-in-part of application No. 11/260,607, filed on Oct. 27, 2005.
Application No. 11/260,607 is a continuation-in-part of application No. 11/536,814, filed on Sep. 29, 2006.

(51) Int. Cl. G11B 7/085

(52) U.S. Cl. 369/30.23; G9B/7.042

(57) ABSTRACT

An optical recording method and recording system for recording data to optical recordable medium are present. An recording system for recording a plurality of data units from a source via a buffer to an optical recordable medium, the apparatus comprising: a pick-up head module (PUH module), a verifier coupled to the PUH module, a buffer management unit for controlling the buffer to buffer data units, and receiving a verifying status signal from the verifier, when the verifying status signal indicating one of recorded data units is verified, generating a transfer control signal for receiving new data unit, and a buffer control signal to control the buffer to release buffer space of the verified data unit to buffer new data unit; wherein after the verifier verifies the second number of the data units, the PUH module follows to an initial position to record a third number of new data units and keeps recording and reading until the plurality of data units being recorded and verified.

### CROSS REFERENCE TO RELATED APPLICATIONS

This application is a Continuation-In-Part of pending U.S. patent application Ser. No. 11/260,607, filed Oct. 27, 2005 and is a Continuation-In-Part of pending U.S. patent application Ser. No. 11/536,814, filed Sep. 29, 2006, the entirety of which are incorporated by reference herein.

### FIELD OF THE INVENTION

The present invention generally relates to a method and a system for recording data to an optical recordable medium, and more particularly to a method and a system for seamlessly transiting from a verifying operation to a recording operation in sequence to record data onto the optical recordable medium and the verifying operation.

### BACKGROUND OF THE INVENTION

After an optical recording apparatus records data to an optical recordable medium, the optical recording system operates a verifying operation to verify the reliability of data just recorded. Data recording-verification performance of a data recording system is limited by the time-consuming and resource hungry verification process, since the storage drive may not retrieve further data for recording prior to the completion of previous data verification. When a defect block is found during the verifying operation, the optical recordable medium allocates a replacement for the defect block, and this operation is called a defect management.

Please refer to FIG. 8, a progress diagram showing of the seeking operations, recording operations, the verifying operations, and the corresponding data units in one recording procedure of the data recording method according to prior arts. Between each recording and verifying, the optical recording apparatus has to perform a seeking process to move the pick up head to the desired position. As shown in FIG. 8, there are fifty-two blocks, in one recording procedure. Since the capacity of the memory for buffering the recording data is limited to twenty data units; therefore, one recording procedure for fifty-two data units is divided into three recording sections.

As shown in FIG. 8, Seeking 101 is to seek a target position of the recording procedure. Recording operation 102 is to record twenty data units B₀˜B₁₉ to the recordable medium initialed from the target position. Seeking 103 is to seeking the target position of the recorded data. Verifying 104 is to read and verify the twenty data units from target position of the recordable medium. Such as Seeking 101, Recording 102, Seeking 103, and Verifying 104 have to repeat three times for recording fifty-two data units, as Seeking 105, Recording 106, Seeking 107, Verify 108, Seeking 109, Recording 110, Seeking 111, and Verify 112 shown in FIG. 8. Either the seeking operations before the recording operations or the verifying operations are time consuming Significantly, the seeking operations deeply influence the entire performance of recording data to the recordable medium and the stability of the optical disc drive system in aforesaid alternation and repeated recording-verifying sequences.

Please refer to FIG. 9, showing waveforms of the data transferring, encoding operation, seeking operation, recording operation and the verifying operation according to prior arts. The fifty-two blocks of one recording procedure are divided into three sections D1, D2, and D3. The first section D1 comprises blocks B₀˜B₁₉, the second section D2 comprises blocks B₂₀˜B₃₉, and the third section D3 comprises blocks B₄₀˜B₅₁. The data transferring is that the optical recording apparatus receives data from a data source to a buffer. The encoding is that the optical recording apparatus encodes data just received from the data source. The recording is to record the encoded data onto the recordable medium. The verifying is to read the data recorded onto the recordable medium and do verify action.

Upon initialization, unrecorded data level increases steadily until reaching an upper threshold in data transferring, where blocks B₀˜B₁₉ is transferred from a data source to the buffer. The data level remains at a constant level throughout seeking 101. Then the data level decreases continuously to a lower threshold during recording 102. Next the data level remains constant throughout seeking 103 and verifying 104 of the complete recorded data blocks B₀˜B₁₉. And the data level increases again in data transferring of the next data section D2 with blocks B₂₀˜B₃₉. The buffer space of the buffer is available only for the next data section D2 with blocks B₂₀˜B₃₉ after the verification of data section D1 is completed. Therefore the time consuming of the whole data storage process, including the recording and verification, suffers from the wait for verification 104.

As shown in FIG. 9, the conventional optical recording apparatus performs the recording operation after the data units of the first section being totally encoded, so a PUH module in the optical recording apparatus always passed over the target position for recording. The optical recording apparatus has to perform another seeking operation to seek the initial position of the next section, such as seeking operation 105, 109. These seeking operations obviously decrease the entire performance of recording data to the recordable medium.

Correspondingly, there is a need to develop an optical recording method and apparatus, which is capable of seamlessly transiting from a verifying operation to a recording operation to improve the entire performance of recording operation. Further, as demand for data access grows, better data recording-verification performance is in favor, so that higher data throughput may be delivered in an unit time. Thus an efficient data storage scheme is needed to speed processing of data recording-verification.

### SUMMARY OF THE INVENTION

One aspect of the present invention is to provide a method of recording a plurality of data units from a source via a buffer to an optical recordable medium, the method comprising: recording a first number of data units to the optical recordable medium; verifying a second number of data units being recorded; preparing for recording a third number of new data units after verifying one recorded data unit of the recorded data units during the verifying step; recording the third number of data units when finishing the verifying step; and repeating the above steps until the plurality of data units being recorded and verified.

Another aspect of the present invention is to provide an recording system for recording a plurality of data units from a source via a buffer to an optical recordable medium, the apparatus comprising: a pick-up head module (PUH module), for controlling a pick-up head (PUH) to record a first number of data units to the optical recordable medium, and controlling the PUH to read a second number of recorded data unit from the optical recordable medium; a verifier coupled to the PUH module, verifying the second number of recorded data units and generating a verifying status signal; a buffer management unit for controlling the buffer to buffer data units, and receiving the verifying status signal, when the verifying status signal indicating one of recorded data units is verified, generating a transfer control signal to control a source interface to receive new data unit, and a buffer control signal to control the buffer to release buffer space of the verified data unit to buffer new data unit; wherein after the verifier verifies the second number of the data units, the PUH module follows to an initial position to record a third number of new data units and keeps recording and reading until the plurality of data units being recorded and verified.

As mentioned above, the optical recording method and recording system according to the present invention provides an efficient data storage scheme and transits from verifying operation to recording operation seamlessly to provide an efficient recording better than the prior art.

### BRIEF DESCRIPTION OF THE DRAWINGS

The foregoing aspects and many of the attendant advantages of this invention will become more readily appreciated as the same becomes better understood by referencing the following detailed descriptions, when taken in conjunction with the accompanying drawings, wherein:

FIG. 1 illustrates a functional block diagram of an recording system for recording data to an optical recordable medium according to the present invention.

FIG. 2 is a progress diagram of seeking operations, recording operations, verifying operations and corresponding data units in one recording procedure according to the present invention.

FIG. 3 shows waveforms of the data transfer operations, encoding operations, seeking operations, recording operations and verifying operations according to the present invention.

FIG. 4 is a flowchart of a recording-verification method according to an embodiment of the invention, incorporating the recording system in FIG. 1.

FIG. 5 shows buffer space allocation of the buffer during the recording operation in FIG. 4, incorporated in the recording system in FIG. 1.

FIG. 6shows buffer space allocation of the buffer during the recording operation in FIG. 4, incorporated in the recording system in FIG. 1.

FIG. 7 shows a flowchart of the optical recording method according to the present invention.

FIG. 8 is a progress diagram of the seeking operations, recording operations and verifying operations and the corresponding data units in one recording procedure according to prior art.

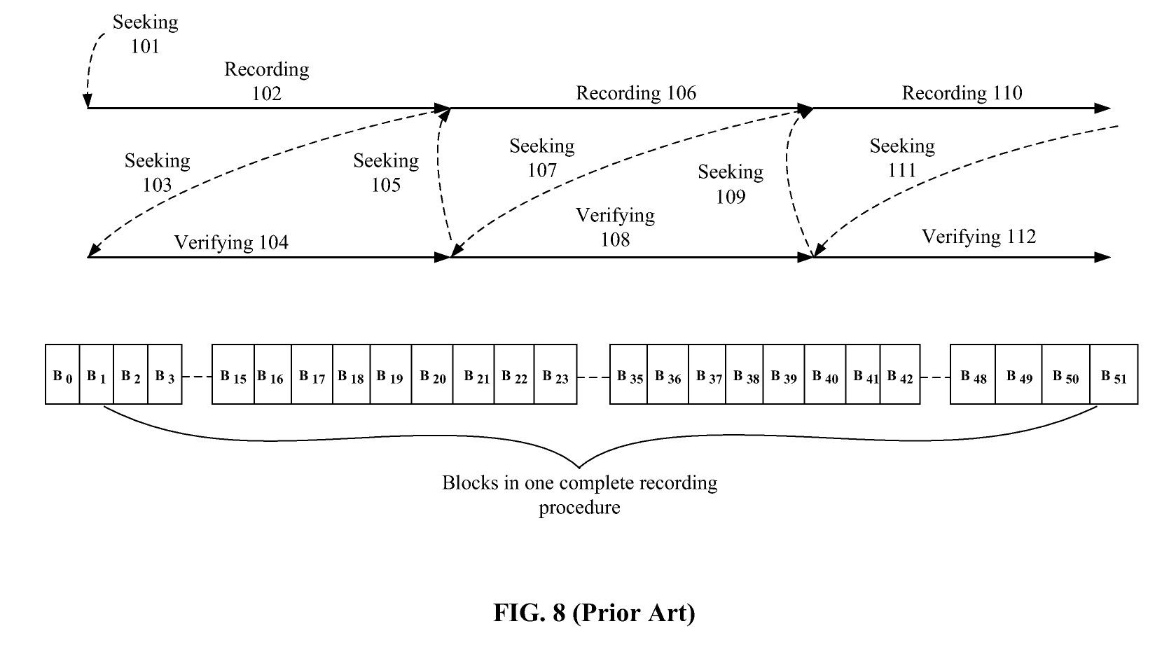

FIG. 9 shows waveforms of the data transfer operations, encoding operations, seeking operation, recording operations and verifying operations according to prior art.

### DETAILED DESCRIPTION OF THE PREFERRED EMBODIMENTS

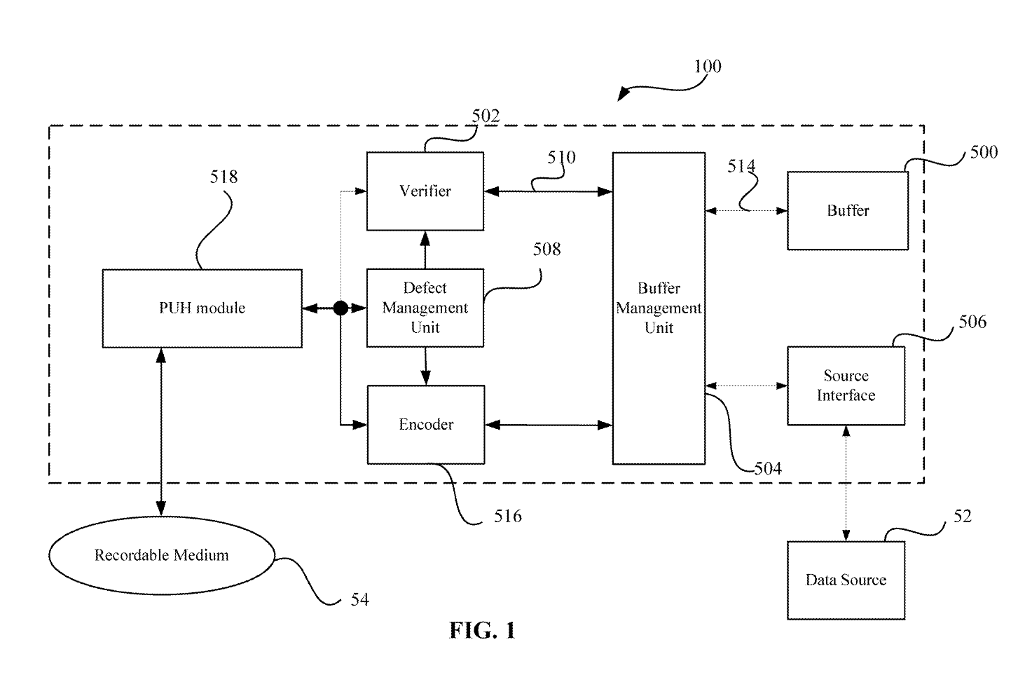

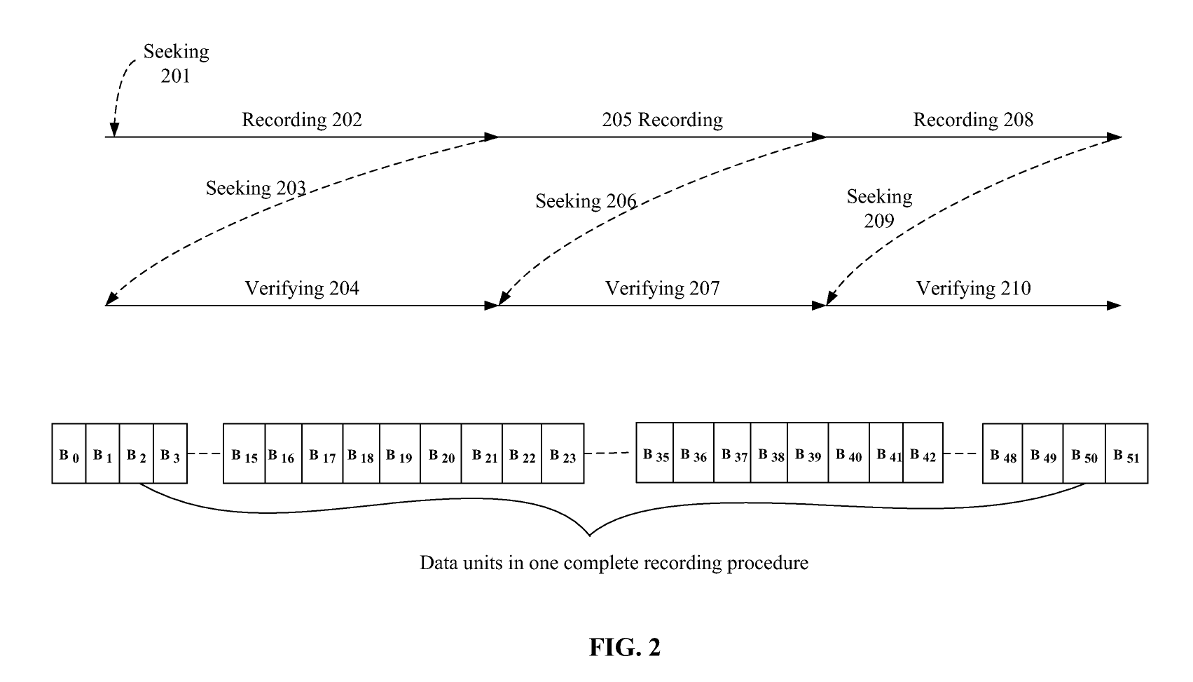

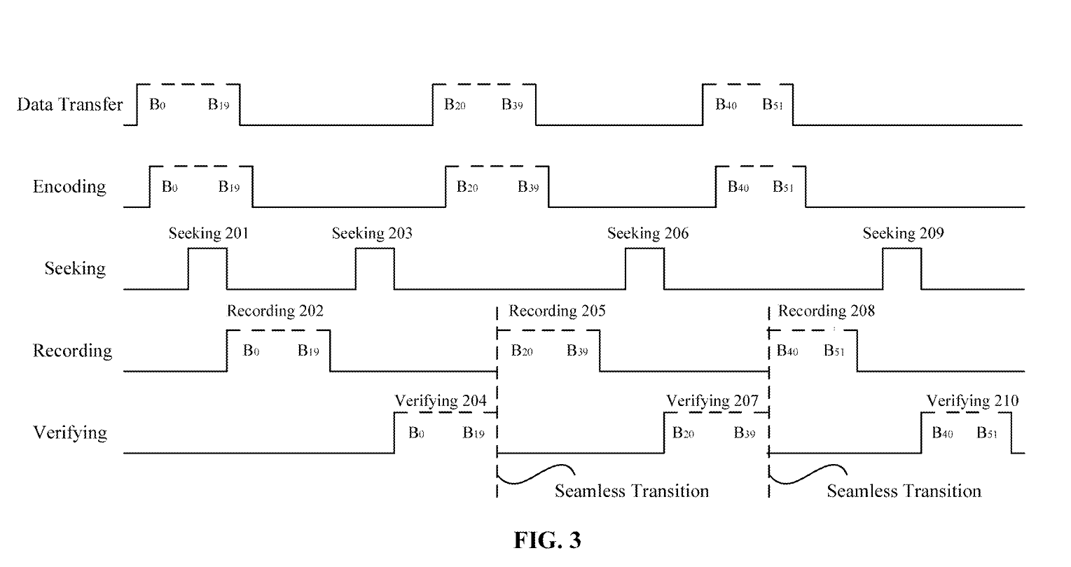

Please refer to FIG. 1, an illustration of a functional block diagram of a recording system for recording data to an optical recordable medium 54 according to the present invention. The recording system 100 comprises a pick-up head module (PUH module) 518, a verifier 502, an encoder 516, a defect management unit 508, a source interface 506, a buffer management unit 504 and a buffer 500. Referring to FIG. 1, buffer 500 is coupled to a buffer management unit 504. The buffer management unit 504 transmits a transfer control signal 514 to the source interface 506 to control the source interface 506 to receive data from the data source 52, and then transmits the data blocks to the buffer 500. The buffer 500 receives and holds data blocks. When buffer management 504 determines that the data capacity level of the buffer 500 reaches a predetermined level, the buffer management generates a start signal to the verifier 502. Please also refer to FIG. 2 and FIG. 3. with FIG. 1. FIG. 2 is a progress diagram of seeking operations, recording operations, verifying operations and corresponding data units in one recording procedure according to an embodiment of the present invention. FIG. 3 shows waveforms of the data transfer operations, encoding operations, seeking operations, recording operations and verifying operations according to the embodiment of the present invention. A recording procedure is performed under a command issued by the data source 200. Based on the command, the data source 200 should transfer the data to the buffer 500 through a source interface 506 between data source 200 and the optical recording apparatus 100. The number of data being transferred each time is limited by the capacity of the buffer 500. For example, the data source 200 commands the optical recording apparatus 100 to record fifty-two data units to the optical recordable medium 54 in a plurality of determined continuation positions of the optical recordable medium 54, and the buffer 500 can only buffer twenty data units, so the data source 200 should at least transfer the data by three times. The data should be divided to a first section (twenty data units, B₀˜B₁₉), a second section (twenty data units, B₂₀˜B₃₉), and a third section (twelve data units, B₄₀˜B₅₁). Upon initialization, data level increases steadily until reaching an upper threshold in data transferring, where data blocks B₀˜B₁₉ is transferred from a data source to the buffer.

After the buffer 500 has any data from the data source for recording, the encoder 516 encodes the data to be data units for recording. The PUH module 518 receives the encoded data units and generating some control signals to control the pick-up head (not shown). The PUH module 518 makes the pick-up head seek to a target position B₀ to generate laser to record the first section of encoded data units B₀˜B₁₉ to the optical recordable medium 54. After the recording operation of the first section of data units B₀˜B₁₉, the PUH module seeks to the target position B₀ and reading back the data units B₀˜B₁₉ recorded to the optical recordable medium 54. The PUH module 518 receives the signal representing the recorded data units B₀˜B₁₉ reflected from the optical recordable medium and then transfers the recorded data units B₀˜B₁₉ to the verifier 502. The PUH module 518 comprises a signal processing unit, and a servo controller in one embodiment of the present invention for performing the above operations. The verifier 502 verifies recorded data units with the encoded data units buffered in the buffer 500. The verifier could be also implemented by a decoder as wild-used by the person skilled in the art. When the verifier 502 verifies a predetermined number of recorded data units of the first section with the corresponding encoded data units buffered in the buffer 500, the memory capacity is released to the data source 200 to let the data source 200 transfers the second section of data. And when the buffer 500 gets the new data from the data source 200, the encoder 516 also starts to encode the new coming data for next recording operation. For example, the data level remains at a constant level during seeking of the recording location in seeking 201. When the recording system starts to record the data onto the recordable medium, the data level decreases continuously to a lower threshold during recording 202. Next, the data level remains constant during seeking verification location in seeking 203 and verification of the first recorded data block B₀ in verifying 204. The data level increases again with the next data transfer D2, while verification of recorded data block B₁, . . . , B₁₉ is in progress in verifying 204. The upper threshold level may be the capacity of the buffer, or less than the capacity. The lower threshold level may be zero, or less than the upper threshold level.

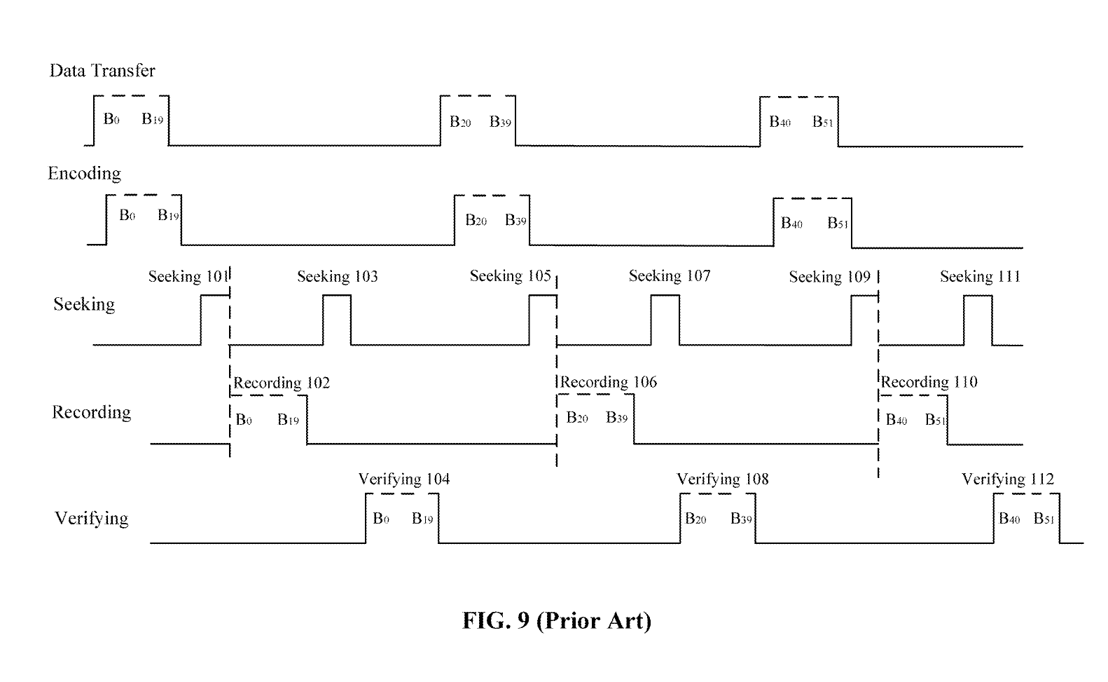

In comparison to FIG. 9, where the second data section D2 starts to transfer after verifying 204, the second data section D2 transferring starts upon partial completion of verifying 204, resulting in better data storage performance in the invention.

The above processes are performed during the PUH module 518, and the verifier 502 performing the first verifying operation. So when the PUH module 518 and the verifier 502 finish the first verifying operation, the encoder 516 and the buffer 500 have prepared enough encoded data units for the PUH module 518 to record to the optical recordable medium 54. According to the present invention, the PUH module 518 follows to a second initial position for recording the second section of data units without another seeking operation between the first verifying operation and the second recording operation. On the other hand, according to the present invention, the hardware latency between the read mode and the write mode transition can be eliminated. After the optical recording apparatus verifies the last data block of the first section, the optical recording apparatus could immediately records the first data block of the second section and without performing any seeking operation, i.e. the PUH module 518 controls the pick-up head to perform a normal following operation from the last data block of the first section to the first data block of the second section continuously. The hardware in the optical recording apparatus could be operated simultaneously; the hardware used for recording could prepare data for recording when the hardware for verifying are used to verify data. As aforementioned, the hardware of the optical recording apparatus according to prior art can only implement one operation at one time, that is, decoding or encoding, seeking, recording, verifying, or defect managing. Meanwhile, it is necessary to execute the seeking operation between the finished verifying operation and the upcoming recording operations in the prior art. The hardware latency (post-process of verifying operation 104 and pre-process of the recording operation 106) cannot be avoided. However, by having aforesaid ability of bi-directional data processing, the processing of the recorded data to be verified in the verifying operations and the processing of the recording data to be written in the recording operations can be executed at the same time. The apparatus of the present invention can prepare the data to be recorded for next recording operation during the time of verifying operation by encoding the data to be recorded and buffering them in the buffer 500. Accordingly, seamlessly transiting from a verifying operation to a recording operation can be achieved.

On the other hand, referring FIG. 1, the verifier 502 receives a part of first section D1 on the recordable medium 54 and verifies the ith part Bᵢ of the data section D1, and outputs verification signal 510 indicating the verification result of the part of recorded data Bᵢ to buffer management unit 504. Buffer management unit 504 in turn controls buffer 500 through buffer control signal 512, and source interface 506 through transfer control signal 514. Verification signal 510 may indicate the verification result.

If recorded data Bᵢ is verified successfully, buffer management unit 504 generates buffer control signal 512, and transfer control signal 514, while verification continues for recorded data Bᵢ₊₁. Buffer control signal 512 releases only the buffer space corresponding to the part of recorded data Bᵢ in buffer 500. Transfer control signal 514 enables further data retrieval at source interface 506. As more buffer space is released, more buffer space in buffer 500 becomes available for the next data transfer from data source 52. Buffer management unit 504 compares the available buffer space in buffer 500 and requested buffer space from data source 52, and generates transfer control signal 514 if the available buffer space exceeds or equals the requested buffer space. Consequently subsequent second section D2 from data source 52 may be received in the released buffer space. Buffer management unit 504 may also enable source interface 506 to receive partial or full data blocks of data section D2, subject to the available buffer space at the time.

Please refer to FIGS. 2 and 3; there are 52 data units, for example, in one recording procedure. Since the capacity of the buffer 500 is limited, one recording procedure may need to be finished by several recording-operations, such as the data units B₀˜B₁₉, the data units B₂₀˜B₃₉, and the data units B₄₀˜B₅₁. First, the apparatus of the present invention executes Seeking 201 for seeking the target position for Recording 202, and then executes the Recording 202. After the Recording 202 is finished, the apparatus of the present invention executes Seeking 203 for seeking the initial position for Verifying 204, and then executes the Verifying 204. During the time of Verifying 204, the apparatus of the present invention prepares for the Recording 205 by receiving the data transferred from the data source and encoding the data to be recorded in advance. Besides, maybe also perform some defect management or any other operation has to be prepared. Said these processes that have to be prepared before recording could be name prepare processes. After the Verifying 204 is finished, the apparatus of the present invention can execute the Recording 205 instantaneously (without any delay) since the data to be recorded was ready.

After the Recording 205 is finished, the apparatus of the present invention executes Seeking 206 for seeking the initial position for Verifying 207, and then executes the Verifying 207. During the time of Verifying 207, the apparatus of the present invention prepares for the Recording 208 as described above. After the Verifying 207 is finished, the apparatus of the present invention executes the Recording 208 instantaneously (without any delay) since the data to be recorded was ready. After the Recording 208 is finished, the apparatus of the present invention executes Seeking 209 for seeking the initial position for Verifying 210, and then executes the Verifying 210. Finally, the one recording procedure for fifty-two data units is completed.

According to the present invention, seamlessly transiting from Verifying 204 to Recording 205 and seamlessly transiting from Verifying 207 to Recording 208 to improve the entire performance of recording data to the optical recordable medium can be achieved. Furthermore, the number of data units recorded in each recording operation is flexible and variable in the present invention to provide efficient flexibility for many possible defects or physical segments which existed on the optical recordable medium. For example, if the aforesaid PUH module obtains the information that one recording procedure is across a boundary of a physical segment, the data unit number of the recording operations can be changed to avoid crossing the boundary of the physical segment for preventing possible error caused by the boundary between two physical segments. In addition, the defect management unit 508 can terminate the Recording 205 when a defect data unit is found in the verified data units of the Verifying 204 in replacing the data of the defect data unit. Similarly, the defect management unit 508 terminates the Recording 208 when a defect is found in the verified data units of the Verifying 207 in replacing the data of the defect. Alternatively, the defect management unit 508 provides a defect mark for the defect when the defect is found in Verifying 204 and 207 and replaces the data of the defect after finishing one recording procedure.

As mentioned above, the number of data units recorded in each recording operation is flexible and variable in the present invention to provide efficient flexibility for recording procedure. In one embodiment, the data source 200, the buffer 500, the encoder 516 prepare a first number of data units for recording, after recording, the verifier can just verify a second number of data units that just recorded to the optical recordable medium 54. The first number and the second number can be the same or different integers, but the second number should be less or equal to the first number. During verifying operation, the data source 200, the buffer 500, the encoder 516 can prepare a third number of data units for next recording. The first number and third number can be the same or different integers, but should be both limited to the memory capacity.

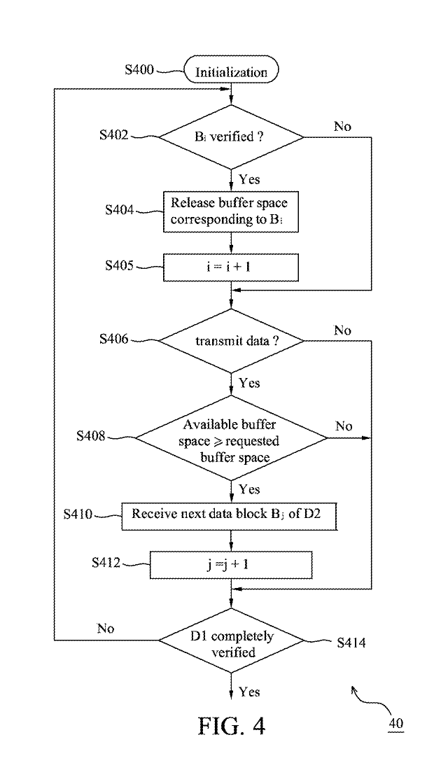

FIG. 4 details a flowchart of a recording-verification method according to an embodiment of the invention, incorporating the recording system in FIG. 1.

During verification, recording-verification method 40 resets counter i=1 and j=20 in step S400, the verifier 502 determines verification result of the recorded data Bᵢ of data section D1 in step S402. If verification signal 510 indicates the verification result is successful, buffer management unit 504 releases only the buffer space corresponding to the part of recorded data Bᵢ in buffer 500 by buffer control signal 512 in step S404, otherwise recording method 40 proceeds to step S406.

Next in step S405, counter i is incremented by 1 such that the next portion of data Bᵢ₊₁ of the first data section D1 can be verified in the next round of verification.

Followed by step S406, buffer management unit 504 checks for the presence of a transmit command from data source 52. Under the condition where the transmit command is absent, method 40 routes to step S414 so that the verification for data Bᵢ continues. If the transmit command is present, buffer management unit 504 evaluates the buffer space requested thereby, estimating the available buffer space in buffer 500, and comparing the requested buffer space with the available buffer space in step S408. If the available buffer space exceeds or equals the requested buffer space, recording method 40 proceeds with step S410, otherwise it routes to step S414. In step S410, buffer management unit 504 generates transfer control signal 514 to permit reception of the second data Bⱼ of the data section D2 from data source 52 to buffer 500.

Next in step S412, counter j is incremented by 1 such that the next data block Bⱼ₊₁ of the second data section D2 can be received at buffer 500 in the next round.

In step S414, buffer management unit 504 determines if data section D1 is completely verified, i.e., if the last data B₁₉ is verified. If it is, method 40 is completed and the system keeps going to process the next data section D2, otherwise, the verification process continues at step S402 until verification of data section D1 is completed. There has to emphasized that the ending of the method 40 only means the data section D1 had been verified completely, not means the whole recording-verification process is completed. The system should keep going to record then verify the following data until the whole data being verified.

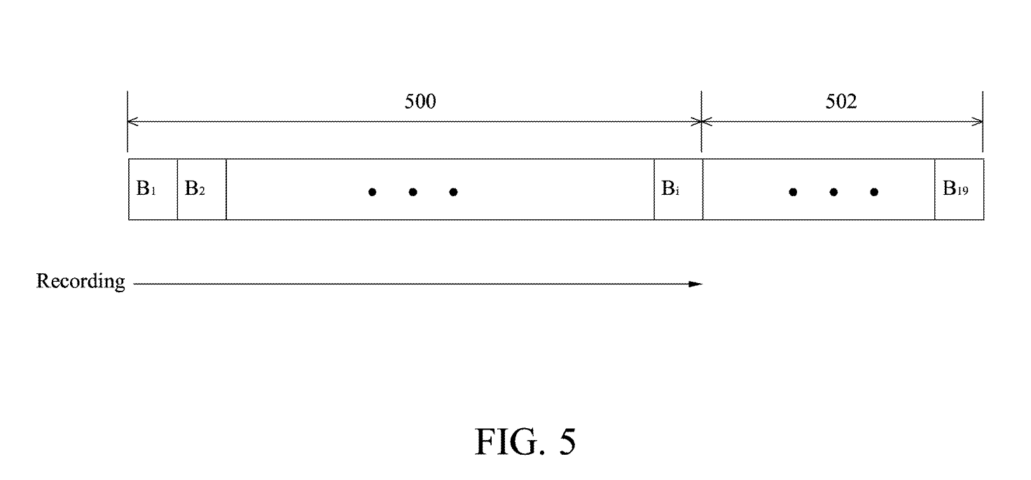

FIG. 5 shows buffer space allocation of buffer 500 during the recording method in FIG. 4, incorporated in the recording system in FIG. 1, comprising recorded data 500 and unrecorded data 502 allocated along the direction of recording progress. The verification step S402 is initiated from the beginning of the recorded data 500, data block B₁, and releases the verified data block B₁ for the next data transfer in step S410.

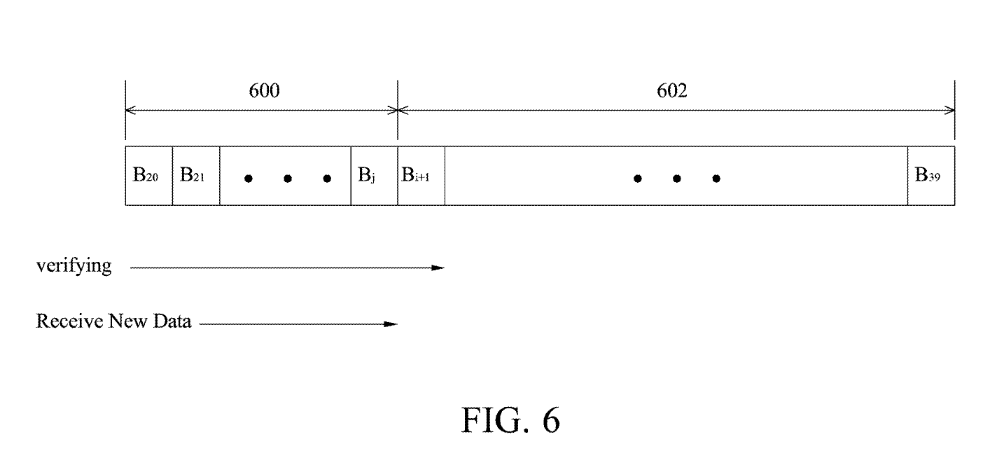

FIG. 6 shows buffer space allocation of buffer 500 during the recording method in FIG. 4, incorporated in the recording system in FIG. 1, comprising unrecorded data 600 and recorded data 602 allocated in agreement with the direction of verification progress in step S602. The data section D2 comprises B₂₀, B₂₁, . . . , Bⱼ and arrives the ring buffer at section 600 along the direction of the verification progress. Thus buffer 500 contains the recorded but unverified data blocks Bᵢ₊₁, . . . , B₁₉ of the data section D1, and unrecorded second data blocks B₂₀, B₂₁, . . . , Bⱼ of the data section D2 simultaneously. As a consequence buffer 500 utilization and time reduction due to buffer space allocation is greatly enhanced. Accordingly, a ring buffer could be used in other embodiments.

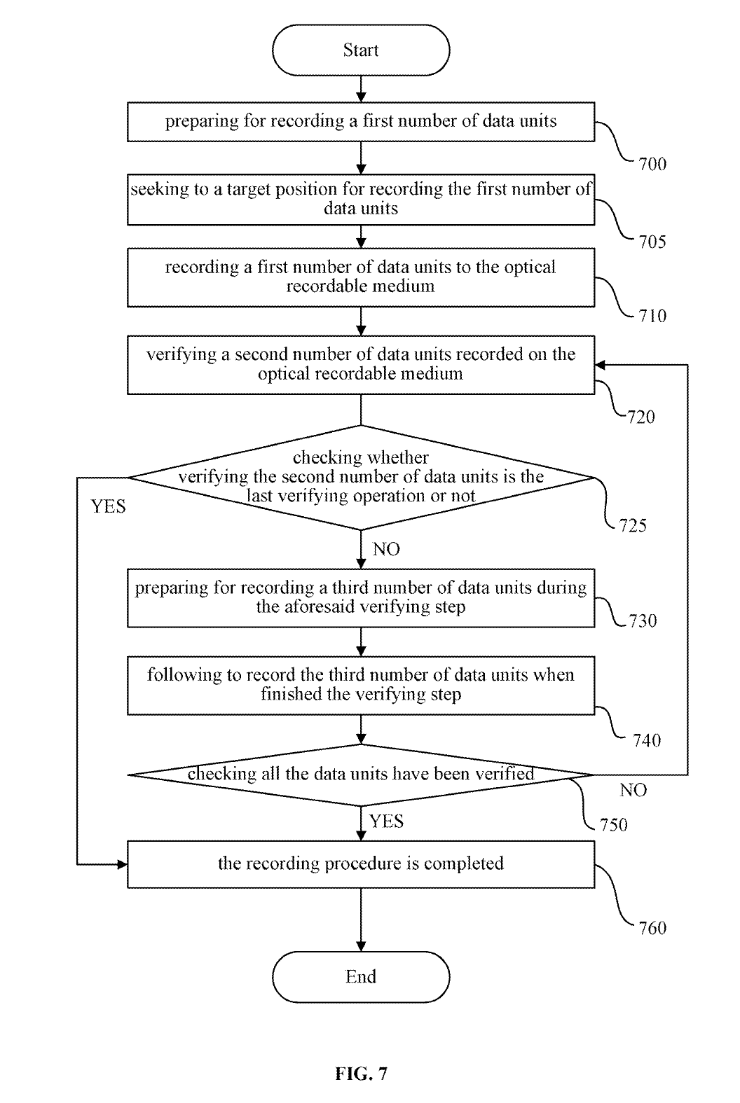

Please refer to FIG. 7. It shows a flowchart of the optical recording method for recording data to the optical recordable medium. The method comprises:

Step 700, preparing for recording a first number of data units;

Step 705, seeking to a target position for recording the first number of data units;

Step 710, recording a first number of data units to the optical recordable medium 54;

Step 720, verifying a second number of data units recorded on the optical recordable medium 54;

Step 725, checking whether verifying the second number of data units is the last verifying operation or not; if yes, go to step 760; if no, go to step 730;

Step 730, preparing for recording a third number of data units during the aforesaid verifying step;

Step 740, following to record the third number of data units when finished the verifying step;

Step 750, checking all the data units have been verified; if yes, go to step 760, if no, go to step 720.

Step 760, the recording procedure is completed.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A method of recording a plurality of data units from a source via a buffer to an optical recordable medium, the method comprising:
recording a first number of data units to the optical recordable medium;
verifying a second number of data units being recorded;
preparing for recording a third number of new data units after verifying one recorded data unit of the recorded data units during the verifying step;
recording the third number of data units when finishing the verifying step; and
repeating the above steps until the plurality of data units being recorded and verified.

2. The method of claim 1, wherein the first number, second number, and the third number are positive integers.

3. The method of claim 1, wherein both the first number and the third number of the data units are limited by a buffer capacity.

4. The method of claim 1, wherein the preparing step comprises encoding the third number of data units.

5. The method of claim 1, wherein the preparing step comprises receiving the third number of data units from a data source.

6. The method of claim 1, wherein the recording steps are initiated at a following position after the verifying step.

7. The method of claim 1, further comprising a step of following to an initial position of a third number of recordable units on the optical recordable medium to record the third number of data units after the verifying step without seeking.

8. The method of claim 1, further comprising:
evaluating required storage size of the new data units; and
estimating available storage size in the storage buffer; and
wherein the new data units are received at the storage buffer if the available storage size exceeds or equals the required storage size.

9. The method of claim 1 further comprising seeking a predetermined verification location having recorded data blocks on the recordable medium for verifying the recorded data.

10. A method of recording a plurality of data units from a source via a buffer to an optical recordable medium, the method comprising:
receiving a first number of data units from the source to the buffer;
recording the first number of data units to the optical recordable medium;
verifying a second number of data units being recorded on the optical recordable medium;
releasing the second number of data units in the buffer when the second number of data units is verified;
receiving a third number of new data blocks from the source at the released buffer space; and
following to an initial position of the third number of recordable units to record the third number of data units after verifying the second number of data unit being recorded on the optical recordable medium.

11. The method of claim 10, wherein the first number, the second number, and the third number are positive integers.

12. The method of claim 10, wherein the first number and the second number of the data units are limited by a buffer capacity.

13. The method of claim 10, further comprising a step of preparing for recording the third number of data units between the verifying and recording steps.

14. The method of claim 10, wherein the following step changes from a verifying operation to a recording operation immediately.

15. The method of claim 10, wherein the following step is following from a last position for last verifying to a initial position for next recording and these two position are continuous positions in the optical recordable medium.

16. The method of claim 10, wherein the step of following to the initial position is without seeking.

17. The method of claim 10, further comprising:
evaluating required storage size of the new data unit; and
estimating available storage size in the buffer; and
wherein the receiving step comprises receiving the new data unit at the buffer if the available storage size exceeds or equals the required storage size.

18. An recording system for recording a plurality of data units from a source via a buffer to an optical recordable medium, the apparatus comprising:
a pick-up head module (PUH module), for controlling a pick-up head to record a first number of data units to the optical recordable medium and to read a second number of data unit being recorded from the optical recordable medium; a verifier coupled to the PUH module, verifying the second number of data units being recorded and generating a verifying status signal; and
a buffer management unit for controlling the buffer to buffer data units, and receiving the verifying status signal, when the verifying status signal indicating one of recorded data units is verified, generating a transfer control signal for receiving new data unit, and a buffer control signal to control the buffer to release buffer space of the verified data unit to buffer new data unit; wherein after the verifier verifies the second number of the data units, the PUH module controls the PUH to follow to an initial position to record a third number of new data units and keeps recording and reading until the plurality of data units being recorded and verified.

19. The recording system of claim 18, wherein the buffer management unit further evaluates required storage size of the new data unit, estimates available storage size in the buffer, and controls the data buffer to receive the new data unit if the available storage size exceeds or equals the required storage size.

20. The recording system of claim 18, wherein the first number, the second number, and the third number are positive integers.

21. The recording system of claim 18, wherein both the first number and the third number of the data units are limited by a buffer capacity.

22. The recording system of claim 18, further comprising an encoder encodes the third number of data units for recording between the verifier finished verifying the second number of data units and the pick-up head starts to record the third number of the encoded data units.

23. The recording system of claim 18, wherein the pick-up head follows to the initial position without seeking.

24. The recording system of claim 18, wherein the buffer comprises the recorded data units and the new data unit.
